(19) United States
(12) Patent Application Publication
(10) Pub. No.: US 2014/0137758 A1
(43) Pub. Date: May 22, 2014

(54) Screen Print Jig

(71) Applicant: Laura Diane Kaye, San Marcos, CA (US)

(72) Inventor: Laura Diane Kaye, San Marcos, CA (US)

(21) Appl. No.: 13/681,111

(22) Filed: Nov. 19, 2012

(51) Int. Cl. B41F 15/34

(52) U.S. Cl. CPC B41F 15/34
USPC 101/126

(57) ABSTRACT

This is a jig that uses the inside of the screen print frame instead of the outside that is used now. It is a improvement because there is only 1 part, and can be used very easily. It can be made any size. It is made by cutting the foam to fit inside the screen print frame. Drawing the grid ½ inch to 1 inch on one side.

Applying the directions on the other side. Then coating the whole jig with epoxy resin.

### WHAT IS THE NAME OF YOUR INVENTION?

New screen print jig

### WHO ARE THE INVENTORS?

Laura Diane Kaye

### WAS THE INVENTION CREATED UNDER A GOVERNMENT CONTRACT?

No

### WHAT DOES YOUR INVENTION ACCOMPLISH?

It helps line up images on each screen print screen.

### BRIEF DESCRIPTION OF DRAWINGS

FIG. 1 is a top view of screen print jig it has a 1 inch grid.

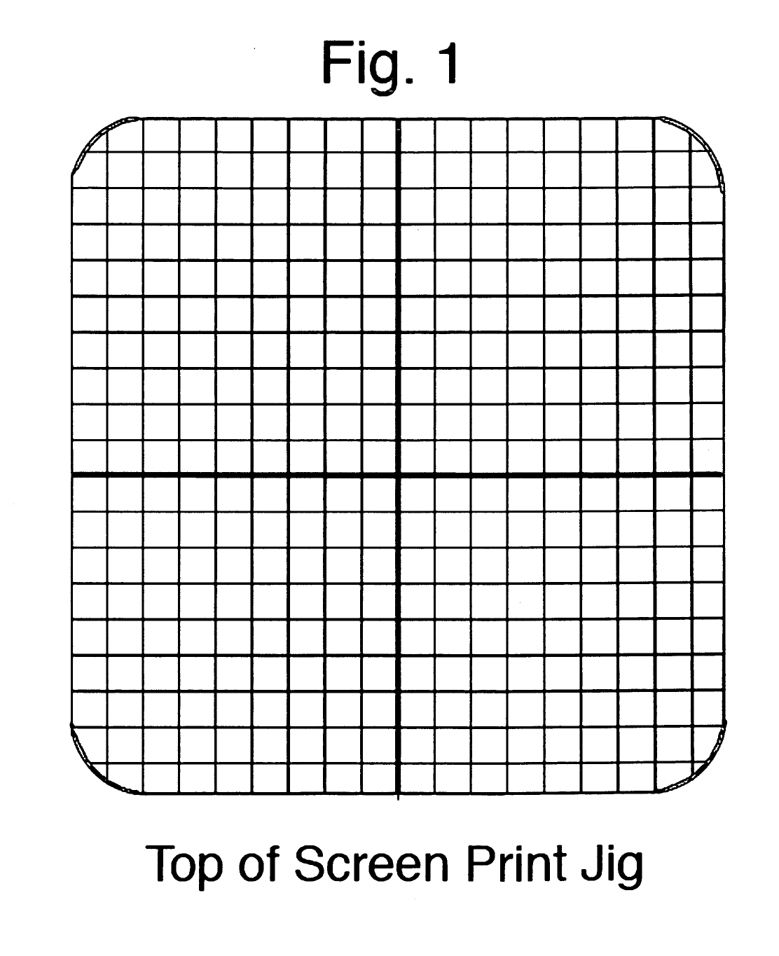

FIG. 2 is a bottom view of screen print jig it has instructions.

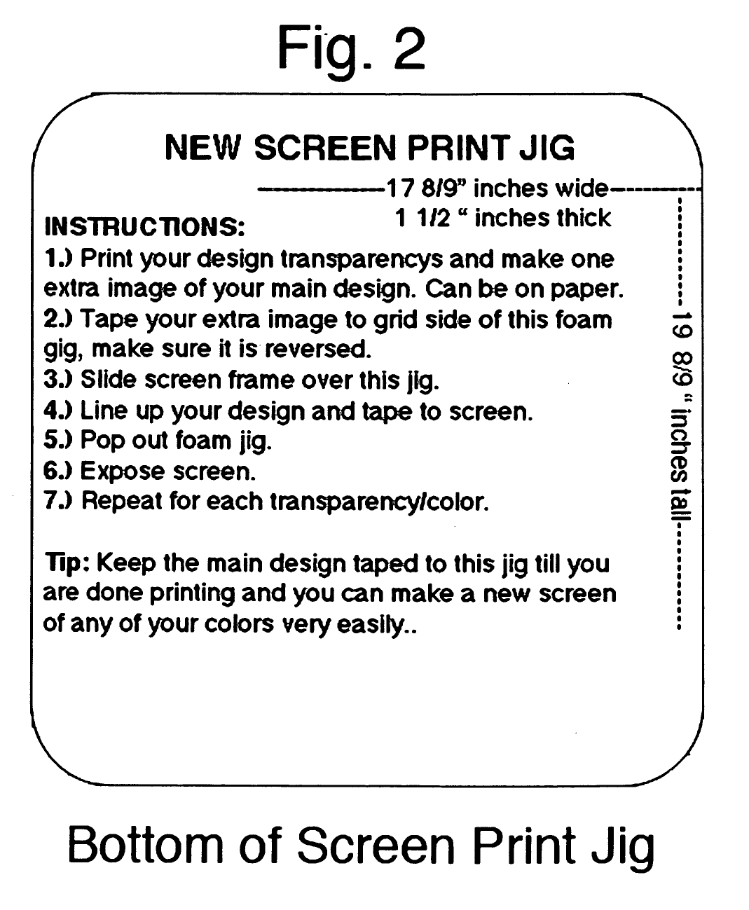

FIG. 3 is a side view of the short side of screen print jig.

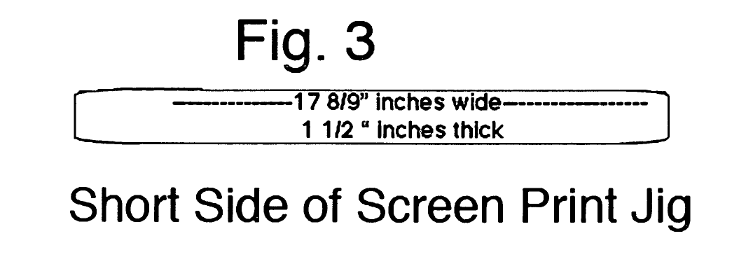

FIG. 4 is a side view of the long side of screen print jig.

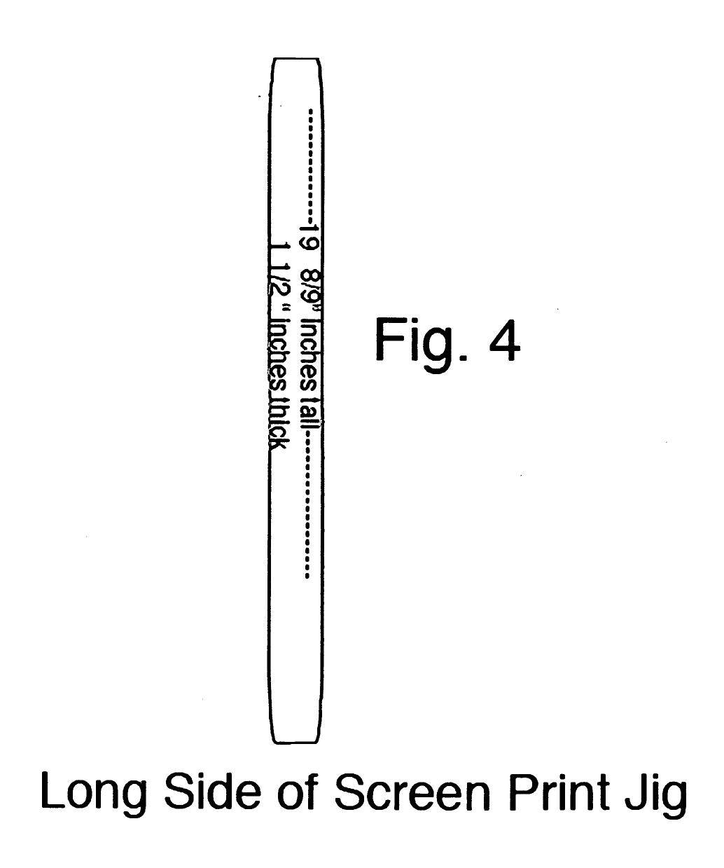

### WHAT ARE THE PARTS OR COMPONENTS?

Core is made of Styrofoam. Top and bottom have a plastic seal and the sides are coated with epoxy resin.

### HOW DO THE COMPONENTS CONNECT?

1 component only

### HOW DOES THE INVENTION OPERATE?

Instructions:

1.) Print your design transparencies and make one extra image of your main design. Can be on paper.

2.)Tape your extra image to grid side of this foam jig, make sure it is reversed.

3.) Slide screen frame over this jig.

4.) Line up your design and tape to screen.

5.) Pop out foam jig.

6.) Expose screen.

7.) Repeat for each transparency/color.

Tip: Keep the main design taped to this jig till you are done printing and you can make a new screen of any of your colors very easily.

### ARE THERE OTHER WAYS TO CONSTRUCT YOUR INVENTION?

Yes, it can be made in other sizes to fit other screens.

### CAN YOUR INVENTION BE USED IN MORE THAN ONE WAY?

Yes, it can be made to fit any screen for screen printing.

1. This jig is used to line up your images on each screen so each image is in the same location for each color that you will print. It can be made any size.
